(19) United States
(12) Patent Application Publication
(10) Pub. No.: US 2026/0180475 A1
(43) Pub. Date: Jun. 25, 2026

(54) METHOD FOR BALANCING COGGING TORQUE OF AN ELECTRICAL MACHINE WITH PERMANENT MAGNET ROTOR AND SLOTTED STATOR, AND RELEVANT ELECTRICAL MACHINE WITH BALANCED COGGING TORQUE

(71) Applicant: IAPF OÜ, Tallinn (EE)

(72) Inventor: Ilmar AAMISEPP, Tallinn (EE)

(73) Assignee: IAPF OÜ, Tallinn (EE)

(21) Appl. No.: 19/125,086

(22) PCT Filed: Nov. 22, 2022
(86) PCT No.: PCT/EP2022/082887

§ 371 Date: Apr. 28, 2025

(51) Int. Cl. H02P 6/10

(52) U.S. Cl. CPC H02P 6/10; H02P 2207/055

(57) ABSTRACT

A method for balancing the cogging torque of an electrical machine with permanent magnet rotor and slotted stator and corresponding electrical machine with balanced cogging torque. According to the method, the actual angular width of magnetic pole shoes of the rotor of the electrical machine is found from the equation Θₘ=k·Θₘₑ, where k is a correction factor taking account of edge effects with value 0.8 . . . 1.1, and Θₘₑ is effective angular width of the magnetic pole shoes of the rotor, determined from the equation Θₘₑ=(Q−1/2)Θₛₚ, where Θ_{Sp} is stator pitch angle and Θ_{Sp}=360°/S and Q is the ratio of the number of slots S and the number of magnetic poles P and an integer, Q=S/P. The value of the correction factor k taking account of the edge effects is determined by modeling the construction of magnetic circuit of the electrical machine with a finite element method.

### TECHNICAL FIELD

The present invention relates to the field of electrical machines, more specifically the field of such electrical machines, in which permanent magnets or direct current electromagnets are used in the rotor of the electrical machine, and comprising a stator made of ferromagnetic material with stator windings installed in its slots. The objective of the invention is to provide a method for balancing and eliminating the total cogging torque of an electrical machine without compromising electromagnetic properties of the electrical machine, and specifically in such electrical machines, where the ratio Q of the number of slots of the stator S and the number of magnetic poles of the rotor P is an integer.

### BACKGROUND ART

The main drawback of electrical machines with permanent magnet rotor, which can be brushless direct current (BLDC) electrical machines or permanent magnet synchronous motor/generators (PMSM/G) with slotted ferromagnetic stator, is the cogging torque occurring in these machines. Cogging torque arises from the interaction of permanent magnets of the rotor and stator slots due to changing magnetic reluctance of the electrical machine above the slot openings. Permanent magnet rotor sets in positions, where magnetic reluctance of the system between the rotor and the stator and mutual interaction energy is minimum, thus forming stable equilibrium states of the system.

In the position of stable equilibrium, the cogging torque is zero and around this position, to the external torque, which takes the rotor out of the position, an opposite torque is added, acting on the rotor towards the position of stable equilibrium. Between two positions of stable equilibrium, there is also a point of unstable equilibrium, where cogging torque is also zero. Disturbance of the torque applied to the rotor in the point of unstable equilibrium causes a condition, where the rotor turns again into the position of stable equilibrium due to the generated cogging torque, which can precede to or follow the position of unstable equilibrium.

Cogging torque is an undesirable phenomenon in the operation of most electrical machines, except a stepper motor, as it causes harmful vibration, noise, higher starting torque, uneven movement and torque ripple, etc. Therefore, several methods have been developed for reducing the cogging torque.

However, most known methods of reducing the cogging torque of the prior art cause deterioration of electromagnetic properties of the electrical machine and often also sophistication of construction, causing more expensive and complicated production.

Thereby, most known methods only reduce the cogging torque of slotted electrical machines to certain extent, but do not eliminate it.

Various patent applications describe also a method or equipment, with which the cogging torque generated in one part of the electrical machine is eliminated with the cogging torque of the same magnitude generated in another part of the electrical machine on the common axis of rotation, but with opposite direction. Such solutions are known from the documents cited below.

CA2711543A1 describes a known solution for reducing cogging torque in electrical machines with permanent magnets. In this solution, a construction component based on permanent magnets, which is unnecessary for work in electromagnetic sense, is added to the electrical machine—cogging torque compensator. Rotor part of the compensator comprises inert mass in addition to the rotor of the electrical machine, increasing inertia of the rotor and thus also the starting torque. The solution is more expensive and less rational than an integral electrical machine, the constructive components of which, compensating the cogging torque, are operating also electromagnetically efficiently (i.e., develop drive torque in the operation of motor or electromotive force and electric current in the operation of generator). This solution enables to reduce total cogging torque, but not to eliminate it.

As the main disadvantage, the described method does not provide a clear, explicit and reproducible solution for designing the shape of cogging torque function of the compensator depending on the rotation angle, so that it would invert (compensate) the cogging torque of the electrical machine.

The solution described in TW201234739A only reduces the cogging torque, but does not eliminate it. This is caused by the lack of solution for the effective angle of magnetic pole shoe of the rotor. A condition necessary for compensating the cogging torque is fulfilled, but not sufficient alone—mechanical shift in two halves of the electrical machine (in stator or rotor) by half period of non-compensated cogging torque function. Further, the described generator construction comprises substantially two electromagnetically independent generators, i.e. it is substantially two electrical machines on a common shaft, but not an integral electrical machine, the two halves of which complement each other mutually in operation.

The solution described in CN212258740U does not provide any description or rule for the angle of magnetic pole shoe of the rotor depending on the stator pitch angle (number of slots). Analogously to the description provided in TW201234739A, a condition necessary for compensating the cogging torque is fulfilled, but not sufficient alone—mechanical shift in two halves of the electrical machine (in stator or rotor) by half period of non-compensated cogging torque function. A further disadvantage is the reduction of cogging torque only for the specific motor construction, while the description does not provide a solution for different types of electrical machines with permanent magnet rotor.

The solution described in US20200153367A1 reduces the cogging torque, but does not fully compensate it. In this solution, an even number of electrical motors are connected to a common shaft. This is not a single integral electrical machine solution, where different halves of the electrical machine would simultaneously participate in the operation of the electrical machine, mutually compensating the cogging torques.

Contemporary industrially manufactured electrical machines with permanent magnet rotor have always one or another method for reducing cogging torque applied. The most common method is use of a machine with fractional slots (the ratio of slots and magnetic poles is not an integer). Without applying the method for reducing the cogging torque or their combination, the electrical machine is practically incapable of operation-cogging torque will be extremely high and comparable to maximum driving torque, wherefore vibration of the machine is practically intolerable from all aspects. Thus, the above-described method can be treated only as an additional method for reducing already tolerable cogging torque in an existing electrical machine.

All the mentioned documents describe the phase shift required for compensating and eliminating the cogging torque by half period of non-compensated cogging torque function between rotor or stator parts of the machine or between parts (stator or rotor) of two machines operating on a common shaft.

Thereby none of these documents mention or provide a clear and comprehensive solution to the problem that the mentioned shift between parts of machine alone is not sufficient for eliminating and/or compensating the cogging torque of an electrical machine. All mentioned documents describe necessary (required), but not sufficient conditions for eliminating (balancing) total cogging torque in electrical machines. The present invention provides new method for creating electrical machines with permanent magnet rotor and slotted stator with balanced cogging torque (zero cogging torque).

### DISCLOSURE OF INVENTION

With uniform distribution of stator slots and rotor poles, cogging torque is a periodical function of the rotation angle of rotor. Twice in a period, after each half period, the cogging torque is equal to zero. This occurs in points of stable and unstable equilibrium, which are alternating. Increase of the absolute value of cogging torque with changing rotation angle (dlTcl)/dΘ may generally be lower around the point of stable equilibrium than around the point of unstable equilibrium, or other way round. However, the extreme values of the cogging torque function (maximum absolute values) generally do not fall on odd quarter periods.

It can be said that generally the cogging torque function is asymmetric from the rotation angle of rotor with its extreme values, i.e. extreme values are not located on odd quarter periods. Phase shift of such function by half period does not provide inversion (antiphase), which could fully compensate the initial function. Thus, for fully compensating the cogging torque with equal, but opposite cogging torque, such conditions should be found, upon fulfillment of which the cogging torque function from the rotation angle is symmetrical with its extreme values or, in other words, the cogging torque function would be possible to invert with phase shift by half period.

Cogging torque is caused by changing reluctance between magnetic pole shoes of the rotor and the stator above the slot openings. Generally, the dependence of the cogging torque function on the rotation angle is determined by the ratio of slot openings and angular width of teeth of the stator to the angular width of magnetic pole shoe of the rotor. Electromagnetically efficient construction of an electrical machine with permanent magnet rotor and slotted stator has low, if any, possibility to deviate from the so-called classical structure of a stator, due to the rules of creating electromagnetically efficient magnetic circuit between rotor and stator.

The most important of those is: to minimize simultaneously magnetic reluctance (between magnetic pole shoes of the rotor and the stator) as well as flux leakage (part of magnetic flux not crossed with current loop). In addition to the above-mentioned rules, the size of stator slot openings is also dictated by technologically minimum required dimension of a slot opening for installing the windings (i.e., wrapping or inserting windings into the slots). This is often the most important factor. Thus, the angular width of stator teeth Θₜ and the angular width of slot opening Θₒ is determined based on the electromagnetic properties and production technological conditions of the electrical machine.

In case of predetermined, Θₜ and Θₒ and their sum Θ_{Sp} (Θ_{Sp} is the stator pitch angle), the only possibility is to control dependence of the cogging torque function on the rotation angle with the angular width of magnetic pole shoe of the rotor. According to an idealized or simplified approach, direction of the magnetic flux between magnetic pole shoe of the rotor and the stator can be considered radial (or the direction of rotation axis in machines with axial flux), not taking account of actually existing edge effects. Such approach enables to determine effective angular width of the magnetic pole shoe of the rotor Θₘₑ, at which the cogging torque function could be inverted with phase shift by half period ½Θ_{c}, where Θ_{c} is the period of cogging torque function and Θ_{c}=360°/S, where the S is number of slots in the stator.

Actual angular width of the magnetic pole shoe of the rotor Θₘ is somewhat different from the effective angular width due to edge effects existing in reality. Namely, a part of magnetic flux runs through the surfaces at the edge and side of magnetic pole shoe, and therefore the angular width of the magnetic pole shoe causing interaction with the stator (effective angular width) differs from the actual. The ratio of actual and effective angular width of the magnetic pole shoe can be expressed with the correction factor k taking account of edge effects, k=Θₘ/Θₘₑ. In case of efficient construction solution, the value of k is in the range 0.8 to 1.1.

The present invention provides a method for balancing the cogging torque of an electrical machine with permanent magnet rotor and slotted stator, wherein the stator has S number of slots and the rotor has P number of magnetic poles, and wherein the ratio of the number of slots S and the number of magnetic poles P is an integer Q.

Rotor and stator comprise two magnetically equal coaxial parts, wherein the mentioned parts of rotor or stator are shifted on the rotational axis in relation to each other by angle Θₛ, where Θₛ=180°/S, which corresponds to half period of the cogging torque function ½Θ_{c}.

According to the method of the invention, the actual angular width of magnetic pole shoes of the rotor is found from the equation
Θₘ=k·Θₘₑ, where k is the correction factor taking account of edge effects with value 0.8 . . . 1.1, and Θₘₑ is effective angular width of the magnetic pole shoes of the rotor, determined from the equation
Θₘₑ=(Q−1/2)Θ_{Sp}, where Θ_{Sp} is stator pitch angle and Θ_{Sp}=360°/S.

The present invention also provides an electrical machine with permanent magnet rotor and slotted stator with balanced cogging torque, wherein the stator has S number of slots and the rotor has P number of magnetic poles, and wherein the ratio of the number of slots S and the number of magnetic poles P is an integer Q. Rotor and stator comprise two magnetically equal coaxial parts, wherein the mentioned parts of rotor or stator are shifted on the rotational axis in relation to each other by angle Θₛ, where Θₛ=180°/S, which corresponds to half period of the cogging torque function ½Θ_{c}.

In the mentioned electrical machine, the actual angular width of magnetic pole shoes of the rotor Θₘ corresponds to the equation Θₘ=k·Θₘₑ, where k is the correction factor taking account of edge effects with value 0.8 . . . 1.1, and Θₘₑ is effective angular width of the magnetic pole shoes of the rotor, corresponding to the equation Θₘₑ=(Q−1/2)Θ_{Sp}, where Θ_{Sp} is stator pitch angle and Θ_{Sp}=360°/S.

Shift by the mentioned angle Θₛ, corresponding to half period ½Θ_{c} of the cogging torque function, takes place in rotor or stator through rotating two parts in relation to each other on the rotational axis by the mentioned angle, but not on both simultaneously.

In the context of the invention, an electrical machine is electric motor or electrical generator.

Angular width of the magnetic pole shoe Θₘ, ensuring inversion of the cogging torque function with phase shift by half period, is generally somewhat different from the effective angular width. This difference is due to the fact that small part of magnetic flux reaches the air gap not through the rotational surface of the magnetic pole shoe, but from edges and sides, and thus the effective angular width of magnetic interaction is somewhat different from the actual angular width of magnetic pole due to the mentioned edge effects. Adjustment of actual angular width of magnetic pole shoe and the construction of magnetic circuit of the rotor, which correspond to the effective angular width of magnetic pole shoe, shall be preferably performed by gradual approximation to the best result, which is the total cogging torque as close to zero as possible, by modeling the construction of magnetic circuit of the electrical machine with finite element method (FEM). This is expressed in the above-mentioned correlation by the correction factor k taking account of the edge effects, the value of which is in the range 0.8 to 1.1.

Other options for adjusting the actual angular width of magnetic pole shoes or determination of the correction factor k can be analytical solution or trial and error approach to the best result, which is the total cogging torque as close to zero as possible.

Hereby it should be noted that a small part of cogging torque cannot be eliminated due to inevitable inaccuracies during manufacture and assembly of the construction of magnetic circuit of the electrical machine. However, in case of good manufacturing and assembly precision this component is negligible.

Value of the correction factor k taking account of the edge effects is preferably determined by modeling the construction of magnetic circuit of the electrical machine with finite element method.

Back EMF shape of electrical machines with balanced cogging torque (zero cogging torque) with permanent magnet rotor and slotted stator enables their realization with trapezoidal back EMF as well as sinusoidal back EMF. Thus, the present invention enables to realize brushless direct current electrical machines with permanent magnet rotor or permanent electromagnet as well as synchronous machines with permanent magnet rotor or permanent electromagnet rotor. For a person skilled in the art it is obvious that instead of permanent magnets direct current powered electromagnets could be used.

As for construction topology, electrical machines with balanced cogging torque (zero cogging torque) with permanent magnet rotor and slotted stator can be realized with inrunner rotor fixed onto rotation shaft, as well as with outrunner rotor. Present invention enables construction of electrical machines with balanced cogging torque or zero total cogging torque with axial as well as radial magnetic flux path. Magnetic poles of the rotor of electrical machine can be formed with surface mounted permanent magnets (SMPM) or interior permanent magnets (IPM), or with an electromagnet within the construction of the rotor.

As for the construction, electrical machines with balanced cogging torque (zero cogging torque) with permanent magnet rotor and slotted stator have preferably two-phase structure. In other options, both two parts of the stator, in case of suitable number of slots, can be equipped with a winding with three or more phases.

### BRIEF DESCRIPTION OF DRAWINGS

The present invention is now described with references to the accompanying schematic figures, where:

FIG. 1A shows examples of diagrams of possible shapes of the functions of cogging torque, with indication of points of stable and unstable equilibrium and also period Θ_{c} of the cogging torque functions, and quarter-periods and half-periods of the cogging torque functions;

FIG. 1B shows an example of non-invertible by half-period ½Θ_{c} phase shift cogging torque function;

FIG. 1C shows an example of invertible by half-period ½Θ_{c} phase shift cogging torque function;

FIGS. 2A to 2F show basic schemes of topology of electrical machines of the invention at values 1 and 2 of the ratio of slots and magnetic poles Q and with shift between parts of the machine in stator or rotor. Basic schemes of topology show schematically the section of stator and rotor. Stator is two-part on all schemes, while slots, slot openings and stator teeth are shown schematically together with indication of angular width of slot opening and teeth, respectively Θₒ and Θₜ. Also, the shift angle Θₛ is indicated, as well as stator pitch angle Θ_{Sp}. Depending on topology, the rotor is single part or two parts, and it is schematically shown between stator parts. For magnetic pole shoes, only their effective angular width Θₘₑ is shown. The actual angular width of magnetic pole shoe Θₘ depends on construction details and is therefore not indicated on the basic schemes of topology (FIGS. 2A to 2F).

FIG. 2A shows basic scheme of topology of the magnetic circuit of an electrical machine, where shift between stator parts in case of two parts rotor is indicated, when Q=1;

FIG. 2B shows basic scheme of topology of the magnetic circuit of an electrical machine, where shift between stator parts in case of two parts rotor is indicated, when Q=2;

FIG. 2C shows basic scheme of topology of the magnetic circuit of an electrical machine, where shift between stator parts in case of single part rotor is indicated, when Q=1;

FIG. 2D shows basic scheme of topology of the magnetic circuit of an electrical machine, where shift between stator parts in case of single part rotor is indicated, when Q=2;

FIG. 2E shows basic scheme of topology of the magnetic circuit of an electrical machine, where shift between rotor parts is indicated, when Q=1;

FIG. 2F shows basic scheme of topology of the magnetic circuit of an electrical machine, where shift between rotor parts is indicated, when Q =2;

FIGS. 3A, 3B and 3C show an example embodiment of two-phase brushless direct current electrical machine produced with the method of the invention at respective sections A-A, B-B and C-C;

FIGS. 4A, 4B, 4C and 4D show an example embodiment of two-phase brushless direct current electrical machine with axial magnetic flux produced with the method of the invention at respective sections A-A, B-B, C-C and D-D, whereby the sections A-A and B-B are made at the air gap of the electrical machine and the section D-D is made from central section of rotor;

FIGS. 5A, 5B and 5C show possible example embodiments of rotor;

FIG. 6 shows back EMF diagrams of the two-phase brushless direct current electrical machine with permanent magnet rotor with balanced cogging torque described in the first example embodiment.

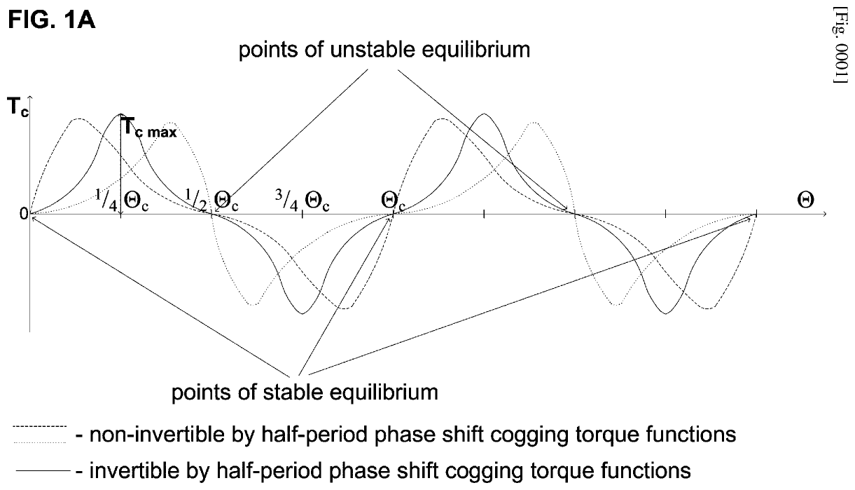

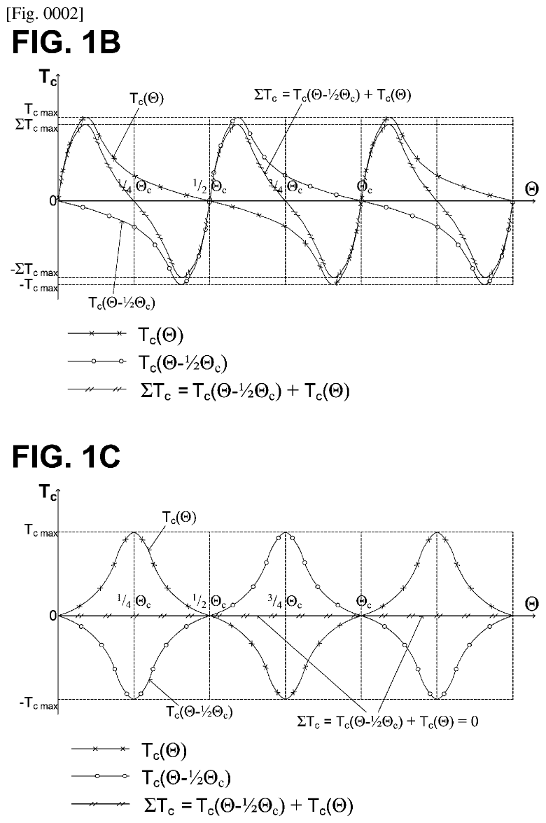

### MODE(S) FOR CARRYING OUT THE INVENTION

For the sake of clarity, similar details and elements are designated with the same reference numbers in different figures.

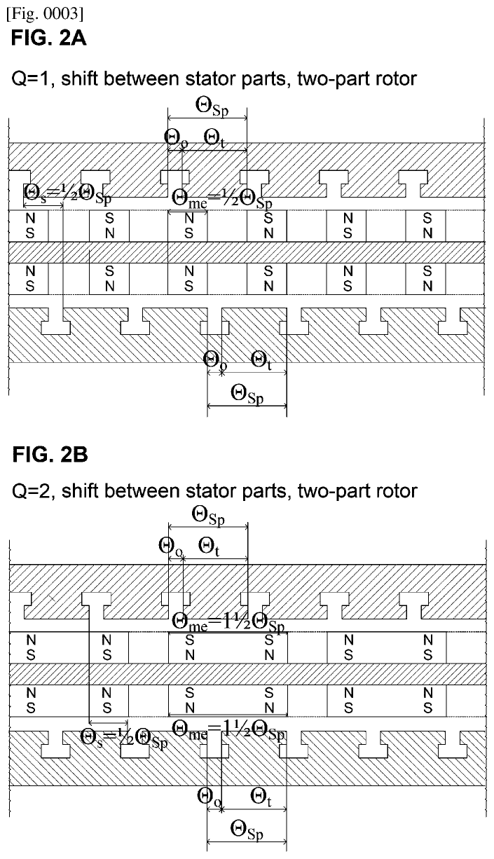

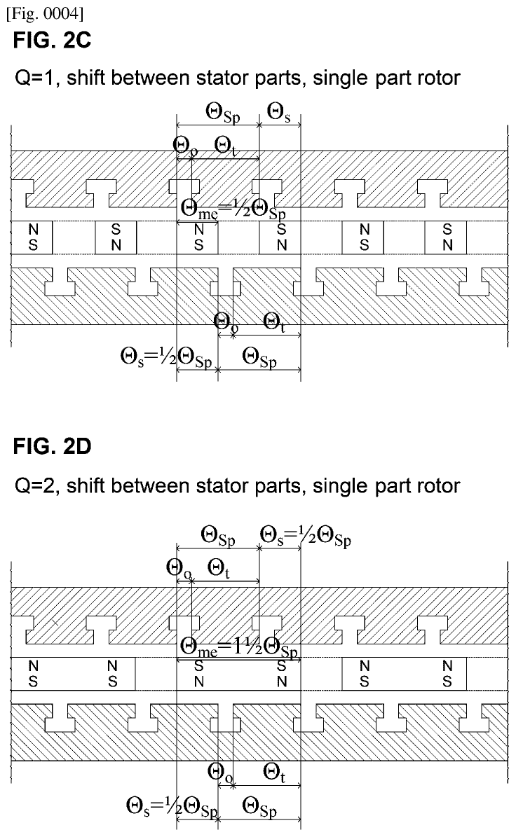

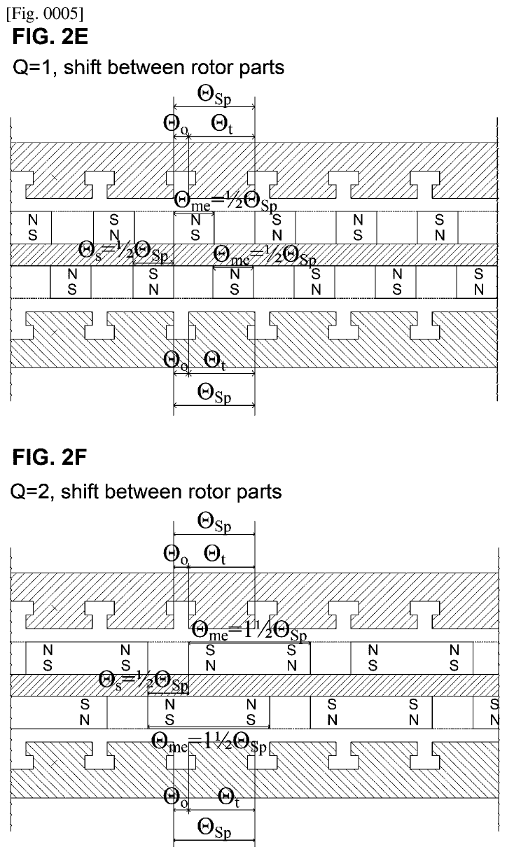

Based on the method of the invention, a brushless direct current electrical machine with permanent magnet rotor and slotted stator with radial magnetic flux is constructed with eight slots in stator and eight magnetic poles (S=8, P=8). The basic topology of the electrical machine corresponds to FIG. 2A. Namely, the ratio of slots and magnetic poles of the machine is 1 (Q=1), the shift by half-period of cogging torque function angle
Θₛ=1/2Θ_{c}=180°/S=22.5° between machine parts is made between stator parts, and rotor consists of two parts, but without a shift between them.

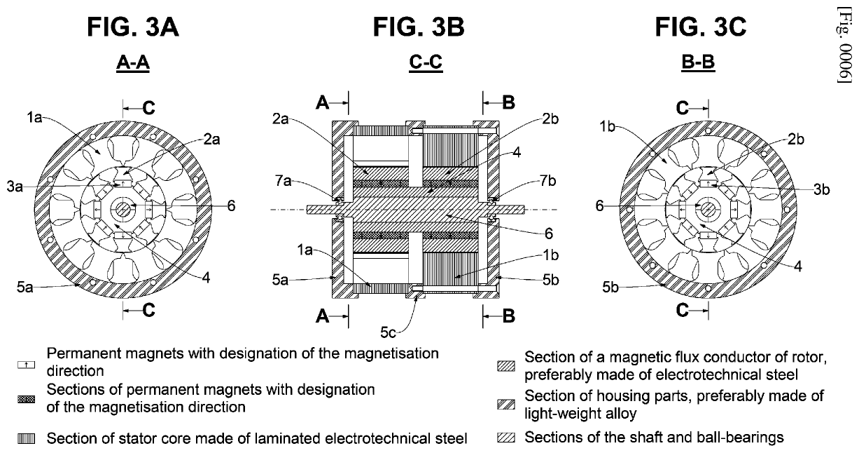

Construction of the mentioned electrical machine is shown in simplified view in three cross sections on FIGS. 3A to 3C, where for the sake of clarity the windings of the electrical machine, some fastening details, bolts, apertures and possible position sensor of the rotor are omitted. Stator parts 1a and 1b are fastened to their separating housing part 5c with shift 22.5° in relation to each other. “Mushroom” magnetic pole shoes of the rotor 2a and 2b are fastened on the permanent magnets 3a and 3b on both halves of the rotor.

The effective angular width of magnetic pole shoes is 22.5° and actual angular width of the curve of rotational surface of pole shoe is 21.875°, ensuring the mentioned effective angular width. Magnetic flux conductor of rotor 4 is common for both rotor halves and permanent magnet sets 3a and 3b of both halves of the rotor are fastened onto it, whereby longitudinal distance of magnet sets 3a and 3b is same as the distance of stator parts 1a and 1b. Magnetic flux conductor of rotor 4 is rigidly fastened to shaft 6, which can freely rotate on ball bearings 7a and 7b, which in turn are fastened in the bearing sockets of housing parts 5a and 5b (end covers).

FIGS. 3A to 3C show the brushless direct current (BLDC) electrical machine with radial magnetic flux with constant air gap size 0.5 mm and permanent magnets in rotor construction, which has P=8 magnetic poles on both halves of the rotor and the same number of stator teeth with angular width 43° (number of slots S=8, stator pitch angle Θ_{Sp}=45°, ratio of the number of slots and the number of magnetic poles Q=S/P=1) on both halves of the stator. The period of non-compensated cogging torque function generated in both parts of the electrical machine is Θ_{c}=360°/8=45°.

To ensure that non-compensated cogging torque achieves maximum upon rotating the rotor by 45°/4=11.25° from the position of stable equilibrium and cogging torque function from the rotation angle is symmetrical to the extreme value, the effective angle of magnetic pole shoe of rotor must be Θₘₑ=(Q−1/2)Θ_{Sp}=1/2 45°=22.5°. Stator halves are fixed in relation to each other with shift angle Θₛ=45°/2=22.5°, corresponding to half-period of non-compensated cogging torque, ensuring the effect of mutually compensating cogging torques applied to rotor parts located on the same shaft. The mentioned shift can be performed also between rotor halves, but in this case the shift has been performed between stator parts due to constructional reasons.

Thereby, the shape of magnetic pole shoes of the rotor should be such that practically the entire magnetic flux would flow in radial direction through the rotational surface of magnetic pole shoe, in order to minimize mutual effect of magnetic pole shoe and stator tooth through side surface of the pole shoe. For this purpose, the cross section of magnetic pole shoe should have e.g. “mushroom” shape. Also, the actual angular width of magnetic pole shoe of the rotor should be made somewhat smaller than effective angular width.

This magnetic circuit construction has achieved the best result with gradual approximation by computer simulations, using the finite element method, and it has been found that in case of the selected geometry of magnetic circuit the actual adjusted angular width of magnetic pole shoe Θₘ shall be 21.875° i.e. correction factor k=0.97(2): Θₘ=Θₘₑ·k=22.5°·0.97(2)=21.875°.

In order to achieve the result, first the non-compensated cogging torque function had to be found, using in the computing model (with FEM software) the actual value of magnetic pole shoe 22.5°, based on which the compensated (balanced) cogging torque function was derived by performing a half-period phase shift with the initial cogging torque function and then summing up the initial and phase shifted functions. Finding that in case of the given angle (22.5°) of magnetic pole shoe the compensated (balanced) cogging torque function differs from zero more than the precision of simulation, the described process had to be continued at each iteration with twice decreased step with actual angles of magnetic pole shoe of the rotor: 22.0°; 21.75°; 21.875°. In case of the last actual angle (21.875°) the compensated (balanced) cogging torque function did not differ from zero more than the precision of simulation, therefore this angular width could be considered the actual angular width of magnetic pole shoe when manufacturing the electrical machine, and the correction factor k taking account of edge effects could be determined, the value of which was 0.97(2).

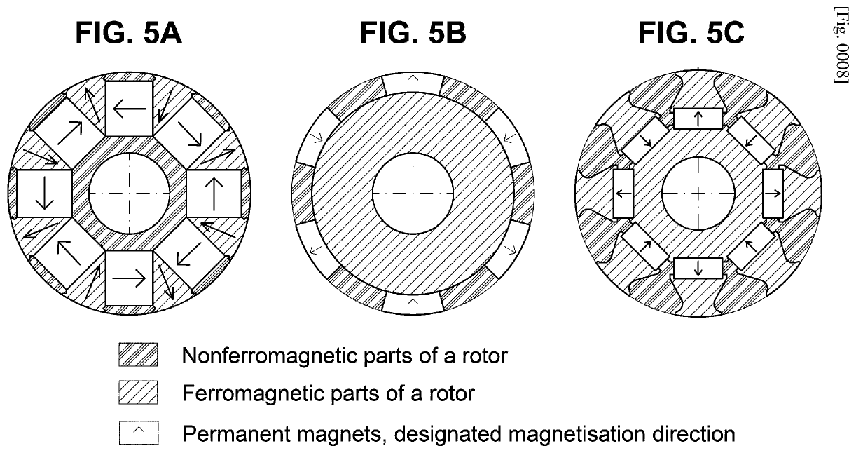

Hereby it should be noted that the described rotor construction is a possible example and is not exclusive. For example, it is also possible to use surface mounted permanent magnets (SMPM) or permanent magnets or permanent electromagnets located in the construction of the rotor differing from the described solution, for which some non-exhaustive examples with radial magnetic flux, inrunner rotor and different number of magnetic poles are provided on FIGS. 5A to 5C.

Thereby it is only essential to ensure that in the selected construction of magnetic circuit the actual angle of magnetic pole shoe would correspond to the correct effective angle, which should be achieved by adjusting the actual size and geometry of magnetic pole shoe with trial-and-error approach, or preferably through computer simulations, using finite element method for gradual approximation to the best result.

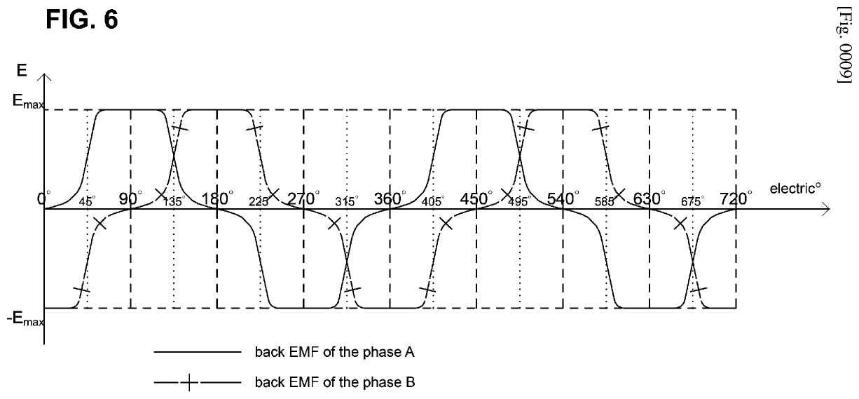

In preferred solution of the described electrical machine, both halves of the stator are equipped with single phase winding, which can be wound as concentrated winding or wave winding. Shapes of back EMF in two-phase structure of the electrical machine are provided on FIG. 6. In the preferred operation of motor, current commutation takes place in the windings of each phase with two H-bridges, one for each phase. In the simplest case, direct commutation can be used for controlling transistors of H-bridges, controlled from rotor position sensors, e.g. with Hall's effect sensor or any other sensor transmitting the position of magnetic pole shoes. Commutation of phase windings can be also controlled without rotor position sensor (sensorless control).

In order to minimize commutation torque ripple, advance angle control by micro-processor can be used.

The main advantage of the described electrical machine of the invention is absence of cogging torque, that is the resulting total cogging torque is zero, which makes its operation smooth and quiet, and enables to use it in applications, which are excluded in case of existence or consequences of cogging torque. For example, the described electrical machine can be used as electric generator in wind turbines, where the absence of cogging torque enables to minimize essentially the minimum wind speed of wind turbine and thus increase the capacity factor. Beside the absence of cogging torque, an electrical machine constructed in accordance with the present invention has much better electromagnetic properties and thus also much higher specific power than other known electrical machines with zero cogging torque-slotless and/or ironless or coreless electrical machines.

Additional advantages of the described brushless direct current electrical machine with balanced cogging torque (zero cogging torque) are:
high specific power;
due to large distances (gaps) between magnetic pole shoes, the machine has good resistance to ferromagnetic dust, which enables cooling with ventilation air also through the interior surfaces of the construction of the machine;
negligible or lacking (when equipped with relevant control system) commutation torque ripple.

Based on the method of the invention, another example of brushless direct current electrical machine with permanent magnet rotor and slotted stator with axial (in the direction of rotational axis) magnetic flux has been constructed. The machine has twelve magnetic poles and twelve slots in the stator (P=12, S=12). The basic topological scheme of the machine corresponds to FIG. 2C. Namely, Q=S/P=1 and the shift by half-period of cogging torque function or angle Θₛ=180°/S=15° is made between stator parts. Rotor is single part and the faces of permanent magnets turned towards stator parts have the role of magnetic pole shoes. Effective angular width Θₘₑ of the latter is 15°.

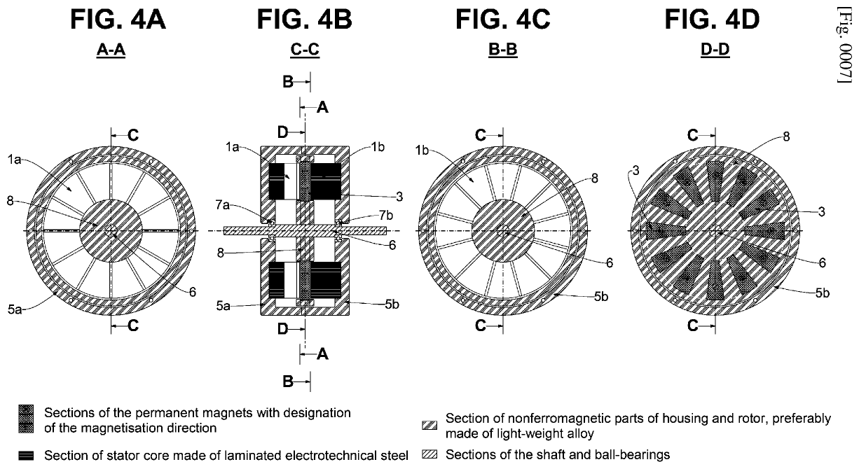

For the sake of clarity, the mentioned electrical machine is shown on FIGS. 4A to 4D with some simplifications. In the mentioned construction drawings, windings of the electrical machine, some fastening details, bolts, apertures and possible position sensor of the rotor are omitted. Stator parts 1a and 1b are fastened respectively to housing parts 5a and 5b with shift 15° in relation to each other. A set of permanent magnets 3, consisting of twelve magnets with ring segment shape, is fastened in the construction of rotor 8, which in turn is rigidly fixed on shaft 6. Shaft 6 can freely rotate on ball bearings 7a and 7b, which are installed in the bearing sockets of housing parts 5a and 5b.

The described electrical machine with axial magnetic flux has similar technical advantages and properties as the above-described electrical machine with radial magnetic flux, by possessing inherently somewhat higher specific power (power density) and drive torque, caused by relatively shorter path of magnetic flux, compared to radial magnetic flux. The machine has relatively lower amount of stator iron and magnetic circuit of rotor consisting only of permanent magnets.

### LIST OF REFERENCE NUMBERS

1a, 1b stator parts
2a, 2b magnetic pole shoe
3 set of permanent magnets
3a, 3b set of permanent magnets
4 magnetic flux conductor
5a, 5b, 5c housing part
6 shaft
7a, 7b ball bearing
8 rotor

1-9. (canceled)

10. A method for balancing a total cogging torque of an electrical machine with a permanent magnet rotor and slotted stator to a zero, wherein the stator has S number of slots and the rotor has P number of magnetic poles, and wherein the ratio of the number of slots S and the number of magnetic poles P is an integer Q, wherein the rotor and the stator comprise two magnetically equal coaxial parts, wherein the parts of the rotor or the stator are shifted on the rotational axis in relation to each other by an angle Θₛ, where Θₛ=180°/S, wherein an actual angular width of magnetic pole shoes of the rotor is found from an equation Θₘ=k·Θₘₑ, where k is a correction factor taking account of edge effects with value 0.8 . . . 1.1, and Θₘₑ is effective angular width of the magnetic pole shoes of the rotor, which is determined from an equation Θₘₑ=(Q−1/2)Θ_{Sp}, where Θ_{Sp} is stator pitch angle and where Θ_{Sp}=360°/S, and Q is equal to 1 or 2.

11. The method of claim 10, wherein the rotor consists of two parts, which are shifted on the rotational axis in relation to each other by angle Θₛ.

12. The method of claim 10, wherein the stator consists of two parts, which are shifted on the rotational axis in relation to each other by angle Θₛ.

13. The method of claim 10, wherein the value of the correction factor k taking account of the edge effects is determined by modelling the construction of magnetic circuit of the electrical machine with a finite element method.

14. An electrical machine with permanent magnet rotor and slotted stator with a zero total balanced cogging torque, wherein the stator has S number of slots and the rotor has P number of magnetic poles, and wherein the ratio of the number of slots S and the number of magnetic poles P is an integer Q, wherein the rotor and stator comprise two magnetically equal coaxial parts, wherein the parts of rotor or stator are shifted on a rotational axis in relation to each other by angle Θₛ, where Θₛ=180°/S, wherein the actual angular width of magnetic pole shoes of the rotor Θₘ corresponds to an equation Θₘ=k·Θₘₑ, where k is a correction factor taking account of edge effects with value 0.8 . . . 1.1 and, Θₘₑ is effective angular width of the magnetic pole shoes of the rotor, which corresponds to the equation Θₘₑ=(Q−1/2)Θ_{Sp}, where Θ_{Sp} is stator pitch angle and Θ_{Sp}=360°/S, and Q is equal to 1 or 2.

15. The electrical machine of claim 14, wherein the rotor consists of two parts, which are shifted on the rotational axis in relation to each other by angle Θₛ.

16. The electrical machine of claim 14, wherein the stator consists of two parts, which are shifted on the rotational axis in relation to each other by angle Θₛ.

17. The electrical machine of claim 14, wherein the electrical machine is an electric motor.

18. The electrical machine of claim 14, wherein the electrical machine is an electric generator.
